(19) United States
(12) Patent Application Publication
(10) Pub. No.: US 2015/0011678 A1
(43) Pub. Date: Jan. 8, 2015

(54) PROCESS FOR PREPARING A MASTERBATCH IN THE LIQUID PHASE

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Jérôme Bibette, Paris (FR); Fernando Martinez Pedrero, Madrid (ES); Benoît De Gaudemaris, Clermont-Ferrand (FR); Julien Berriot, Clermont-Ferrand (FR)

(21) Appl. No.: 14/364,265

(22) PCT Filed: Dec. 12, 2012
(86) PCT No.: PCT/EP2012/075210

§ 371 Date: Jun. 10, 2014

(30) Foreign Application Priority Data
Dec. 14, 2011 (FR) 1161632

(51) Int. Cl. C08K 5/41; C08J 3/205; C08J 3/22; B01D 61/24; C08K 3/04

(52) U.S. Cl. CPC C08K 5/41; B01D 61/243; C08K 3/04; C08J 3/22; C08J 3/2053
USPC 523/351

(57) ABSTRACT

The invention relates to a process for preparing a masterbatch in the liquid phase based on one or more diene elastomer latexes and on one or more fillers which coagulate spontaneously with said latex, comprising the following successive steps:
preparing a stable and homogeneous aqueous dispersion (C) containing one or more surfactants, by mixing
one or more diene elastomer latexes (A) with
one or more aqueous dispersions (B) of one or more fillers which coagulate spontaneously,
homogenizing the aqueous dispersion (C),
reducing the chemical potential of the surfactant in the aqueous dispersion (C) until coagulation of said diene elastomer latex(es) with the filler(s),
recovering the coagulum,
drying the recovered coagulum in order to obtain the masterbatch.

This application is a 371 national phase entry of PCT/EP2012/075210, filed 12 Dec. 2012, which claims benefit of FR 1161632, filed 14 Dec. 2011, the entire contents of which are incorporated herein by reference for all purposes.

### BACKGROUND

1. Field

The disclosure relates to a process for preparing a masterbatch in the liquid phase of one or more diene elastomers, in particular a natural rubber latex, and of one or more fillers which coagulate spontaneously with said latex.

The term “masterbatch” is intended to mean: an elastomer-based composite into which one or more fillers and optionally other additives have been introduced.

2. Description of Related Art

It is known that, in order to obtain the optimum reinforcing properties imparted by a filler to a tire tread, and thus to obtain high wear resistance, it is generally advisable for this filler to be present in the elastomeric matrix in a final form that is both as finely divided as possible and as uniformly distributed as possible. However, such conditions can be achieved only if this filler has a very good capacity, on the one hand, to be incorporated into the matrix during the mixing with the elastomer and to deagglomerate, and, on the other hand, to disperse uniformly in this matrix.

As it happens, in order to improve the dispersibility of the filler in the elastomeric matrix, it is known practice to make use of a mixture of elastomer and filler in the “liquid” phase. To do this, use is made of an elastomer in latex form and an aqueous dispersion of the filler, commonly referred to as “slurry”.

The process for preparing a masterbatch in the liquid phase comprises a coagulation step, which is generally initiated by adding a coagulating agent to the medium. U.S. Pat. No. 5,763,388 teaches a process for preparing, in the liquid phase, a masterbatch of a polymer latex and of silica as filler, comprising the incorporation of a modified silica into the latex. This silica was reacted beforehand with a coupling agent, this modification of the silica making it possible to uniformly disperse the modified silica in the polymer latex. According to said document, the coagulation step is carried out in the presence of a coagulating agent.

The filler may also be carbon black. In this field, as early as 1955, the problem of the uniform dispersion of fillers, and in particular of carbon black, in rubber had already been raised. Thus, a process for preparing a masterbatch of rubber and of carbon black in the liquid phase is known from document BE 541816. This process is carried out continuously and uses hydraulic shocks or else violent mechanical stirring to disperse the carbon black in the elastomeric matrix.

More recently, document WO 97/36724 discloses a process for preparing a masterbatch and specific equipment for improving the dispersibility of carbon black in a natural rubber latex. This technology meets two objectives: carrying out the coagulation step in the absence of coagulating agent, and obtaining a masterbatch in which the distribution of the filler is uniform. However, this technology has a certain number of drawbacks. The equipment used is very complex and the process described relies on very precise characteristics linked to this equipment, such as a defined coagulation zone geometry or else a defined flow speed difference.

### SUMMARY

Thus, a process for preparing a masterbatch is sought, which results in a masterbatch in which the distribution of the filler is uniform throughout the product, and in which the weight yield and the filler/elastomer ratio are satisfactory, this process having to be easy to carry out using simple equipment.

Furthermore, it would be advantageous to be able to have better control of, or even to control, the homogenization and coagulation phases so as to be able to act on the distribution of the filler within the coagulum.

As it happens, the applicants have discovered that it is possible to control the homogenization of the mixture of the elastomer and the filler before the coagulation phase, thus making it possible to improve the distribution of the fillers in the elastomeric matrix, and to cause all the fillers present in the matrix to contribute, thus resulting in a very good weight yield while respecting the amount of filler previously introduced.

Advantageously, the process according to embodiments of the invention does not require the use of a coagulating agent.

The invention, in an embodiment, thus relates to a process for preparing a masterbatch in the liquid phase based on one or more diene elastomer latexes and on one or more fillers which coagulate spontaneously with said latex, comprising the following successive steps:
preparing a stable and homogeneous aqueous dispersion (C) containing at least one surfactant, by mixing

one or more diene elastomer latexes (A) with

one or more aqueous dispersions (B) of one or more fillers which coagulate spontaneously,
homogenizing the aqueous dispersion (C),
reducing the chemical potential of the surfactant in the aqueous dispersion (C) until coagulation of said diene elastomer latex(es) with the filler(s),
recovering the coagulum, then
drying the recovered coagulum in order to obtain the masterbatch.

The invention also relates, in an embodiment, to a masterbatch of diene elastomer and of filler, prepared according to the process described above.

A subject of the invention, in an embodiment, is also a rubber composition based on at least one masterbatch of diene elastomer and of filler, prepared according to the process described above, a finished or semi-finished article comprising a composition as defined above, and a tire tread comprising a composition as defined above.

Finally, a subject of the invention, in an embodiment, is a tire or semi-finished product comprising at least one rubber composition as defined above.

Other subjects, features, aspects and advantages of the invention will emerge even more clearly upon reading the description and the examples which follow.

### DETAILED DESCRIPTION OF SPECIFIC EMBODIMENTS

For the purposes of the present invention, the term “uniform” is intended to mean, conventionally for those skilled in the art, that the concentration of fillers and/or of elastomer latex in a given volume is identical to the concentration of fillers and/or of latex in the total volume of the masterbatch or of the dispersion.

Those skilled in the art will be able to verify the uniformity of the dispersion, if required, by means of measurements of concentration of the filler and/or the elastomer latex using several samples taken at various places (for example at the surface or deeper in the vessel) of the volume of the dispersion.

The desired objective is to avoid the formation of pockets of dispersion of fillers in the masterbatch, commonly known as agglomerates.

The expression composition “based on” should be understood as meaning a composition comprising the mixture and/or the reaction product of the various constituents used, some of these base constituents being capable of reacting or intended to react with one another, at least in part, during the various phases of production of the composition, in particular during the chemical crosslinking thereof.

In the present description, unless expressly indicated otherwise, all the percentages (%) are percentages by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The unit of quantity “phr” signifies parts by weight per hundred parts of elastomer.

Preparing the Aqueous Dispersion (C)

The first step of the process according to the invention consists in preparing a stable and homogeneous aqueous dispersion (C) containing one or more surfactants from one or more elastomer latexes (A) with one or more aqueous dispersions of fillers (B).

For the purposes of the present invention, the term “stable aqueous dispersion” is intended to mean a dispersion in which the constituents of this dispersion do not coagulate, do not flocculate, do not comprise any agglomerate and do not sediment, at least macroscopically, i.e. its state does not change over a predetermined time at ambient temperature under atmospheric pressure.

More particularly, the stable dispersion does not change macroscopically over time with respect to the spontaneous coagulation resulting from the mixing of carbon black and of a natural rubber latex.

Diene Elastomer Latex (A)

For the purposes of the present invention, the term “elastomer in latex form” is intended to mean an elastomer which is in the form of elastomer particles dispersed in water.

The invention relates to diene elastomer latexes, the diene elastomers being defined as follows:

A “diene” elastomer or rubber should be understood, in a known way, as meaning an elastomer resulting at least in part (i.e., a homopolymer or a copolymer) from diene monomers (monomers carrying two conjugated or non-conjugated carbon-carbon double bonds).

These diene elastomers can be classified into two categories: “essentially unsaturated” or “essentially saturated”. Generally, the term “essentially unsaturated” is intended to mean a diene elastomer resulting at least in part from conjugated diene monomers having a content of units of diene origin (conjugated dienes) which is greater than 15% (mol %); thus it is that diene elastomers such as butyl rubbers or copolymers of dienes and α-olefins of EPDM type do not come within the preceding definition and can in particular be described as “essentially saturated” diene elastomers (low or very low content, always less than 15%, of units of diene origin). In the category of “essentially unsaturated” diene elastomers, the term “highly unsaturated” diene elastomer is intended to mean in particular a diene elastomer having a content of units of diene origin (conjugated dienes) which is greater than 50%.

Among these diene elastomers, natural rubber and synthetic elastomers are furthermore distinguished.

For natural rubber (NR), which is particularly suitable for the invention, this natural rubber exists in various forms, as explained in detail in Chapter 3, “Latex concentrates: properties and composition”, by K. F. Gaseley, A. D. T. Gordon and T. D. Pendle in “Natural Rubber Science and Technology”, A. D. Roberts, Oxford University Press—1988.

In particular, several forms of natural rubber latex are sold: the natural rubber latexes referred to as “field latexes”, the natural rubber latexes referred to as “concentrated natural rubber latexes”, epoxidized latexes (ENRs), deproteinized latexes, latexes having undergone an amide bond cleavage step, or else prevulcanized latexes and modified latexes. The natural rubber field latex is a latex to which ammonia has been added in order to prevent premature coagulation and the concentrated natural rubber latex corresponds to a field latex which has undergone a treatment corresponding to washing, followed by concentration. The various categories of concentrated natural rubber latex are listed in particular according to Standard ASTM D 1076-06. Singled out in particular among these concentrated natural rubber latexes are concentrated natural rubber latexes of the grade referred to as: “HA” (high ammonia) and of the grade referred to as “LA”; for the invention, use will advantageously be made of concentrated natural rubber latexes of HA grade.

The latex can be used directly or be diluted beforehand in water to facilitate the processing thereof.

In the expression “synthetic diene elastomers capable of being used in accordance with the invention”, the term “diene elastomer” is intended more particularly to mean:

(a)—any homopolymer obtained by polymerization of a conjugated diene monomer having from 4 to 12 carbon atoms;

(b)—any copolymer obtained by copolymerization of one or more conjugated dienes with one another or with one or more vinylaromatic compounds having from 8 to 20 carbon atoms;

(c)—a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;

(d)—a copolymer of isobutene and isoprene (butyl rubber), and also the halogenated versions, in particular chlorinated or brominated versions, of this type of copolymer.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure, which depends on the polymerization conditions used, in particular on the presence or absence of a modifying and/or randomizing agent and on the amounts of modifying and/or randomizing agent employed. The elastomers can, for example, be block, statistical, sequential or microsequential elastomers and can be prepared in dispersion or in solution; they can be coupled and/or star-branched or else functionalized with a coupling and/or star-branching or functionalization agent. Mention may for example be made, for coupling to carbon black, of functional groups comprising a C—Sn bond or aminated functional groups, such as aminobenzophenone, for example; mention may for example be made, for coupling to a reinforcing inorganic filler, such as silica, of silanol or polysiloxane functional groups having a silanol end (such as described, for example, in FR 2 740 778 or U.S. Pat. No. 6,013,718 and WO 2008/141702), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or polyether groups (such as described, for example, in EP 1 127 909 or U.S. Pat. No. 6,503,973, WO 2009/000750 and WO 2009/000752). Mention may also be made, as other examples of functionalized elastomers, of elastomers (such as SBR, BR, NR or IR) of the epoxidized type.

The following are suitable: polybutadienes, in particular those having a content (mol %) of 1,2-units of between 4% and 80% or those having a content (mol %) of cis-1,4-units of greater than 80%, polyisoprenes, butadiene/styrene copolymers and in particular those having a Tg (glass transition temperature, measured according to ASTM D3418) of between 0° C. and −70° C. and more particularly between −10° C. and −60° C., a styrene content of between 5% and 60% by weight and more particularly between 20% and 50%, a content (mol %) of 1,2-bonds of the butadiene part of between 4% and 75% and a content (mol %) of trans-1,4-bonds of between 10% and 80%, butadiene/isoprene copolymers, in particular those having an isoprene content of between 5% and 90% by weight and a Tg of −40° C. to −80° C., or isoprene/styrene copolymers, in particular those having a styrene content of between 5% and 50% by weight and a Tg of between −5° C. and −50° C. In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content (mol %) of 1,2-units of the butadiene part of between 4% and 85%, a content (mol %) of trans-1,4-units of the butadiene part of between 6% and 80%, a content (mol %) of 1,2-plus 3,4-units of the isoprene part of between 5% and 70% and a content (mol %) of trans-1,4-units of the isoprene part of between 10% and 50%, and more generally any butadiene/styrene/isoprene copolymer having a Tg of between −5° C. and −70° C., are in particular suitable.

To summarize, the synthetic diene elastomer or elastomers according to the invention are preferably selected from the group of highly unsaturated diene elastomers formed by polybutadienes (abbreviated to BRs), synthetic polyisoprenes (IRs), butadiene copolymers, isoprene copolymers and the mixtures of these elastomers. Such copolymers are more preferably selected from the group consisting of butadiene/styrene copolymers (SBRs), isoprene/butadiene copolymers (BIRs), isoprene/styrene copolymers (SIRs) and isoprene/butadiene/styrene copolymers (SBIRs).

Thus, as synthetic elastomer latex, the latex can in particular consist of a synthetic diene elastomer already available in the form of an emulsion (for example, a butadiene/styrene copolymer, SBR, prepared in emulsion) or consist of a synthetic diene elastomer initially in solution (for example, an SBR prepared in solution) which is emulsified in a mixture of organic solvent and water, generally by means of a surface-active agent.

An SBR latex, in particular an SBR prepared in emulsion (“ESBR”) or an SBR prepared in solution (“SSBR”), and more particularly an SBR prepared in emulsion, is particularly suitable for the invention.

There are two main types of processes for the emulsion copolymerization of styrene and butadiene, one of them, or hot process (carried out at a temperature close to 50° C.), being suitable for the preparation of highly branched SBRs, whereas the other, or cold process (carried out at a temperature which can range from 15° C. to 40° C.), makes it possible to obtain more linear SBRs.

For a detailed description of the effectiveness of several emulsifiers which can be used in said hot process (as a function of the contents of said emulsifiers), reference may be made, for example, to the two papers by C. W. Carr, I. M. Kolthoff and E. J. Meehan, University of Minnesota, Minneapolis, Minn., which appeared in the Journal of Polymer Science of 1950, Vol. V, No. 2, pp. 201-206, and of 1951, Vol. VI, No. 1, pp. 73-81.

Regarding comparative examples of the implementation of said cold process, reference may be made, for example, to the paper Industrial and Engineering Chemistry, 1948, Vol. 40, No. 5, pp. 932-937, E. J. Vandenberg and G. E. Hulse, Hercules Powder Company, Wilmington, Del., and to the paper Industrial and Engineering Chemistry, 1954, Vol. 46, No. 5, pp. 1065-1073, J. R. Miller and H. E. Diem, B. F. Goodrich Chemical Co., Akron, Ohio.

In the case of an SBR elastomer (ESBR or SSBR), use is in particular made of an SBR having a moderate styrene content, for example of between 20% and 35% by weight, or a high styrene content, for example from 35% to 45%, a content of vinyl bonds of the butadiene part of between 15% and 70%, a content (mol %) of trans-1,4-bonds of between 15% and 75% and a Tg of between −10° C. and −55° C.; such an SBR can advantageously be used as a blend with a BR preferably having more than 90% (mol %) of cis-1,4-bonds.

It should be noted that it is possible to envisage using one or more natural rubber latexes as a blend, one or more synthetic rubber latexes as a blend, or a blend of one or more natural rubber latexes with one or more synthetic rubber latexes.

According to one preferred embodiment of the invention, the process uses an aqueous dispersion of natural rubber, and more particularly a concentrated latex of natural rubber, and in particular a concentrated natural rubber latex of the grade referred to as: “HA” (high ammonia) and of the grade referred to as “LA”. More particularly, the concentrated natural rubber latex of the grade referred to as: “HA” (high ammonia) is used.

The concentration of natural rubber in the aqueous dispersion (A) ranges from 10% to 65% by weight, preferably from 30% to 65% by weight, and in particular from 40% to 65% by weight relative to the total weight of the dispersion (A).

Aqueous Dispersion of One or More Fillers (B)

The fillers according to the invention coagulate spontaneously with the diene elastomer.

Use may be made of any type of reinforcing filler known for its abilities to reinforce a rubber composition which can be used for the manufacturing of tires.

These fillers can be selected from a reinforcing organic filler, such as carbon black, a chemically modified reinforcing inorganic filler, a chemically modified reinforcing organic filler, an organic/inorganic hybrid filler, a polymer-based filler, and mixtures thereof, these fillers all coagulating spontaneously with the diene elastomer latex.

Preferably, the fillers are selected from carbon black, carbon black modified with organic functions, carbon black treated with silica and silica modified with organic functions.

For example, it is possible to use a blend of two types of different fillers, in particular a blend of carbon black and modified inorganic filler.

The organic filler that can be used in the aqueous dispersion (B) according to the invention is preferably carbon black.

All known carbon blacks, in particular blacks of the HAF, ISAF or SAF type, conventionally used in tires (“tire-grade” blacks), are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks.

Use may also be made, according to the applications targeted, of blacks of higher series FF, FEF, GPF or SRF, for example the N660, N683 or N772 blacks. Mention may be made, as examples of organic fillers other than carbon blacks, of functionalized polyvinylaromatic organic fillers, as described in Applications WO-A-2006/069792 and WO-A-2006/069793, for instance hydrophobic polyvinylaromatic fillers.

In the aqueous dispersion (B) comprising the fillers, the concentration of fillers is preferentially between 0.1% and 20%, preferentially between 1% and 15% by weight relative to the water present in the aqueous dispersion of filler (B).

It is known that carbon black coagulates spontaneously with natural rubber latexes, i.e. the coagulation begins, macroscopically, virtually instantaneously the moment the carbon black is brought into contact with the latex, under a very low shear.

As it happens, it has been observed, surprisingly, that the reduction of the chemical potential of the surfactant present in the aqueous dispersion (C) is a factor which initiates coagulation of the medium.

The surfactant(s) may be present in the diene elastomer latex (A), or else in the aqueous dispersion of fillers (B) or alternatively both in the diene elastomer latex (A) and in the aqueous dispersion of fillers (B).

Surfactants

Thus, the aqueous dispersion of filler (C) comprises one or more surfactants, in particular in such a way as to render it stable.

This surfactant may be anionic, non-ionic, cationic or amphoteric.

Non-ionic surfactants are compounds which are well known per se (see in particular in this regard “Handbook of Surfactants” by M. R. Porter, published by Blackie & Son (Glasgow and London), 1991, pp 116-178). Thus, they can in particular be selected from (non-limiting list) alcohols, alpha-diols and alkyl phenols, these compounds being polyethoxylated and/or polypropoxylated and having a fatty chain comprising, for example, 8 to 18 carbon atoms, it being possible for the number of ethylene oxide or propylene oxide groups to range in particular from 2 to 50. Mention may also be made of copolymers of ethylene oxide and of propylene oxide, condensates of ethylene oxide and propylene oxide with fatty alcohols; polyethoxylated fatty amides preferably having from 2 to 30 mol of ethylene oxide, polyglycerolated fatty amides comprising on average 1 to 5 glycerol groups and in particular 1.5 to 4; oxyethylenated fatty acid esters of sorbitan having from 2 to 30 mol of ethylene oxide; polyethoxylated oils preferably having from 2 to 50 mol of ethylene oxide; fatty acid esters of sucrose, fatty acid esters of polyethylene glycol, alkylpolyglycosides, N-alkylglucamine derivatives, amine oxides such as (C₁₀-C₁₄)alkylamine oxides or N-acylaminopropylmorpholine oxides, and oxyethylenated and/or oxypropylenated polydimethylsiloxanes.

The amphoteric or zwitterionic surfactant(s) that can be used in the present invention may in particular be secondary or ternary, optionally quaternized, aliphatic amine derivatives in which the aliphatic group is a linear or branched chain comprising from 8 to 22 carbon atoms, said amine derivatives containing at least one anionic group, such as, for example, a carboxylate, sulphonate, sulphate, phosphate or phosphonate group. Mention may in particular be made of (C₈-C₂₀)alkylbetaines, sulphobetaines, (C₈-C₂₀alkyl)amido(C₃-C₈ alkyl)betaines or (C₈-C₂₀ alkyl)amido(C₆-C₈ alkyl)sulphobetaines.

By way of example, mention may be made of the cocoamphodiacetate sold by the company Rhodia under the name Miranol® C2M concentrate.

Among the amphoteric or zwitterionic surfactants mentioned above, use is preferably made of (C₈-C₂₀)alkylbetaines such as cocoylbetaine, (C₈-C₂₀alkyl)amido(C₃-C₈ alkyl)betaines such as cocoylamidopropylbetaine, and mixtures thereof. More preferentially, the amphoteric or zwitterionic surfactant(s) is (are) selected from cocoylamidopropylbetaine and cocoylbetaine.

The term “anionic surfactant” is intended to mean a surfactant comprising only anionic groups as ionic or ionizable groups. These anionic groups are preferably selected from the groups CO₂H, CO₂⁻, SO₃H, SO₃⁻, OSO₃H, OSO₃⁻, H₂PO₃, HPO₃⁻, PO₃²⁻, H₂PO₂, HPO₂⁻, PO₂²⁻POH and PO⁻.

By way of examples of anionic surfactants that can be used in the composition according to the invention, mention may be made of alkyl sulphates, alkyl ether sulphates, alkylamido ether sulphates, alkylaryl polyether sulphates, monoglyceride sulphates, alkylsulphonates, alkylamidesulphonates, alkylarysulphonates, alpha-olefin sulphonates, paraffin sulphonates, alkyl sulphosuccinates, alkyl ether sulphosuccinates, alkylamide sulphosuccinates, alkyl sulphoacetates, acylsarcosinates, acylglutamates, alkyl sulphosuccinamates, acylisethionates and N-acyltaurates, polyglycoside polycarboxylic acid and alkyl monoester salts, acyl lactylates, salts of D-galactoside uronic acids, salts of alkyl ether carboxylic acids, salts of alkylaryl ether carboxylic acids, salts of alkylamido ether carboxylic acids; and the corresponding non-salified forms of all these compounds; the alkyl and acyl groups of all these compounds comprising from 6 to 24 carbon atoms and the aryl group denoting a phenyl group.

When the anionic surfactant(s) is (are) in salt form, it (they) may be selected from the alkali metal salts, such as the sodium or potassium salts and preferably the sodium salt, the ammonium salts, the amine and in particular amino alcohol salts, or the alkaline-earth metal salts, such as the magnesium salt.

By way of examples of a cationic surfactant, mention may in particular be made of primary, secondary or tertiary fatty amine salts, quaternary ammonium salts, such as tetraalkylammonium, alkylamidoalkyltrialkylammonium, trialkylbenzylammonium, trialkylhydroxyalkylammonium or alkylpyridinium chlorides or bromides; imidazoline derivatives; or amine oxides with a cationic nature.

Preferably, the surfactant used is selected from anionic, non-ionic and amphoteric surfactants, and mixtures thereof.

Preferably, anionic surfactants are used, and in particular alkyl sulphates. Preferably, a single surfactant is used. The surfactant which is particularly preferred is sodium dodecyl sulphate.

For the chemical potential, reference may be made to the book Atkins, Physical Chemistry, 8th edition, Oxford University press, p 148 et seq.

In particular, the chemical potential of a constituent in solution is directly linked to its concentration in the medium.

Thus, it has been observed, surprisingly, that, starting from a system (dispersion (C)) in which the amount of surfactant is such that it prevents coagulation from taking place, modification of the chemical potential of the surfactant to again initiate coagulation. Thus, one of the steps of the process consists in reducing the chemical potential of the surfactant in the system until coagulation of the diene elastomer latex with the fillers in the aqueous dispersion (C).

In the context of this invention, the chemical potential will be calculated relative to the chemical potential of the surfactant at a fixed reference concentration (Cref) of 0.5 g/100 ml, in pure water, at the temperature of the experiment, using the following formula:

Chemical potential of the surfactant=R×T×ln(C/Cref)

ln which R is the ideal gas constant,

T denotes the temperature expressed in Kelvin, and In is the natural logarithm function. Preferably, the experiment is carried out in a temperature range of between 20 and 30° C.

Generally, when the chemical potential of an entity is not identical in each point of the medium, then the entity will have a tendency to migrate to its lowest chemical potential point. The free enthalpy of the system is thus minimized, in accordance with the second principle of thermodynamics.

In the aqueous dispersion (C), the chemical potential of the surfactant is preferentially strictly greater than 0 J/mol, in order for the system to be stable. This means that, after coagulation, the chemical potential of the dispersion (C) is less than 0 J/mol.

Preparation of the Diene Elastomer Latex (A)

When the diene elastomer latex (A) contains one or more surfactants, the latter are added to the latex. Said latex is then stirred in order to dissolve the surfactant in the latex and to homogenize the dispersion (A). The latex may also undergo a concentration or dilution step in order to form the latex (A).

Preparation of the Aqueous Dispersion of Filler (B)

In order to prepare the aqueous dispersion of filler (B), the filler(s) according to the invention is (are) dispersed in water. When the aqueous dispersion of filler (B) contains one or more surfactants, the latter are added to water before or after the introduction of the filler(s).

Advantageously, the filler is fragmented by sonification or by passing it through a tool of rotor-stator type or of high-pressure homogenizer type or of microfluidizer type, which makes it possible to improve the dispersibility of the filler in the masterbatch subsequently produced.

According to one particular embodiment of the invention, the diene elastomer used is a natural rubber and the organic filler used is carbon black.

Bringing into Contact of the Two Dispersions and Homogenization Phase

The diene elastomer latex (A) and the dispersion of filler (B) are brought into contact. The dispersion of filler is slowly poured into the elastomer latex, or vice versa, with preferably slow stirring so as to ensure good homogenization of the medium. The mixing of the dispersions (A) and (B) can also be carried out by bringing one into contact with the other simultaneously with controlled flow rates.

The control of the duration of the phase of homogenization of the latex and of the dispersion of filler makes it possible to act directly on the uniformity of the medium, and of the final masterbatch.

The more effective the homogenization phase is, the more uniform the distribution of the fillers in the coagulum will be.

It is possible to use any type of apparatus which enables “effective” mixing of two products in the liquid phase; thus, use may be made of a static mixer such as those sold by the companies Noritake Co., Limited, TAH in the USA, Koflo in the USA, or Tokushu Kika Kogyo Co., Ltd. or a high-shear mixer, such as mixers sold by Tokushu Kika Kogyo Co., Ltd., or by the company PUC in Germany, by the company Cavitron in Germany or by the company Silverson in the United Kingdom.

Reduction of the Chemical Potential

The chemical potential of the surfactant present in the aqueous dispersion (C) is reduced until coagulation of the medium.

This reduction can be carried out, for example, according to two distinct embodiments: by dialysis of the aqueous dispersion (C) or else by injection of the aqueous dispersion (C) into a large volume of aqueous solution, with a precoagulation step beforehand.

By Dialysis of the Aqueous Dispersion (C)

According to a first embodiment, the aqueous dispersion (C) is placed in a dialysis bag, characterized by a semi-permeable membrane, i.e. a membrane which is impermeable to the natural rubber latex and to the fillers and permeable to the surfactant and to water.

For example, the dialysis tubing that can be used according to the invention may be the tubing sold by the company Spectrum under the name Spectra/Por CE dialysis tubing, characterized by a cut-off threshold of 100 kD.

This dialysis bag is placed in a reservoir containing an aqueous solution.

This aqueous solution may be pure water, or else an aqueous solution comprising the surfactant(s) present in the aqueous dispersion (C) in a particular concentration.

This concentration must be such that the chemical potential of the surfactant(s) in the bath is lower than the chemical potential which initiates coagulation. Consequently, the chemical potential of the surfactant(s) in the bath is lower than the chemical potential of the surfactant(s) in the aqueous dispersion (C), so as to cause the surfactant to migrate from the dialysis bag to the reservoir, thus resulting in a reduction in its chemical potential in the aqueous dispersion (C), and then in the coagulation of the entities present in the aqueous dispersion (C).

When the chemical potential of the surfactant in the dialysis bag moves below a threshold potential characteristic of the aqueous dispersion (C), coagulation takes place in the dialysis bag.

According to this embodiment, the volume of the aqueous solution may be greater than 5 times the volume of the aqueous dispersion (C), preferably greater than or equal to 50 times the volume of the aqueous dispersion (C).

By Injection of the Aqueous Dispersion (C) into a Large Volume of Aqueous Solution

According to a second embodiment, the process according to the invention is carried out by injection/dilution into/in a volume of aqueous solution.

The aqueous solution which is of use for this embodiment is identical to that used for the dialysis.

According to this embodiment, the volume of the aqueous solution may be greater than 5 times the volume of the aqueous dispersion (C), preferably greater than or equal to 50 times the volume of the aqueous dispersion (C).

This embodiment involves a step of precoagulation of the medium. This precoagulation step is, for example, carried out by providing the dispersion (C) with mechanical energy, for example in the form of stirring with a spatula. This provision of energy makes it possible to initiate coagulation in the dispersion (C), which then forms a gel with a weak cohesion (low elasticity), thereby making it possible to inject the dispersion (C) into the bath without the constituent elements of the dispersion (C) separating out and becoming diluted. During the phase of coagulation of these two dispersions, a coagulum of elastomer and filler forms, either in the form of a single solid element in the solution, or in the form of several separate solid elements.

According to one preferred embodiment of the invention the surfactant is sodium dodecyl sulphate. It is introduced into the dispersion (B) in a concentration strictly greater than 0.035 mol/litre, preferably between 0.035 mol/litre (limit excluded) and 0.35 mol/litre relative to the water.

The amount of carbon black in the dispersion (B) is between 4% and 12% by weight relative to the water.

The dispersion of latex (A) consists of HA-grade natural rubber at 60% by weight of NR.

The dispersion (A) and the dispersion (B) are mixed at equal weight (or at equal weight flow rate), at a temperature of 23° C.

After reduction of the chemical potential of the surfactant in the dispersion (C), which makes it possible to cause coagulation, the concentration of SDS in the dispersion (C) is less than 0.018 mol/litre.

The volume of aqueous dispersion of the filler (B) depends on the amount of filler targeted for the masterbatch to be produced, on the volume of the diene elastomer latex (A) and on the concentrations of (A) and of (B).

Thus, the volume will be adjusted accordingly. Advantageously, the amount of filler targeted for the masterbatch is between 10 and 150 phr, preferably between 10 and 100 phr and more preferentially between 15 and 90 phr, even more preferentially between 15 and 70 phr.

Preferably, the process according to the invention does not comprise the addition of a coagulating agent.

According to another embodiment, it is possible to add, to the dispersion (C), one or more coagulating agents and/or a provision of mechanical energy so as to improve the yield of the coagulation step. If this happens, the coagulating agent is not the factor responsible for initiating the coagulation, nor is the provision of mechanical energy.

Recovery of the Solid Formed

The solid(s) is (are) recovered for example by filtration or by centrifugation. Indeed, the filtering operation, which can be carried out by means of a filtration sieve, may prove to be unsuitable when the coagulum is in the form of numerous small solid elements. In such a case, an additional centrifugation operation is preferably carried out.

After this filtering or centrifugation step, the coagulum obtained is dried, for example by ordinary means: in an oven, by vacuum drying, under a gas stream, in a drum dryer, or by a thermomechanical means such as an extruder, a kneader or an internal mixer. From the industrial productivity point of view, continuous tools are preferable, such as continuous kneaders or extruders. The process according to the invention can be carried out both continuously and in a batchwise manner.

Additives

The diene elastomer latex (A) and the aqueous dispersion of filler (B) in accordance with the invention can also comprise all or a portion of the usual additives generally used in elastomer compositions intended for the manufacture of tires, in particular of treads, such as, for example, plasticizers or extending oils, whether the latter are aromatic or non-aromatic in nature, pigments, protective agents, such as antiozone waxes, chemical antiozonants or antioxidants, anti-fatigue agents, reinforcing resins, methylene acceptors (for example, phenolic novolak resin) or methylene donors (for example, HMT or H3M), as described, for example, in Application WO 02/10269, a crosslinking system based either on sulphur or on sulphur donors and/or on peroxide and/or on bismaleimides, vulcanization accelerators or vulcanization activators, with the exception, of course, of zinc-based activators (or in accordance with the 0.5 phr maximum for zinc in the composition, and preferably less than 0.3 phr).

Preferably, these dispersions comprise, as preferred non-aromatic or very weakly aromatic plasticizing agent, at least one compound selected from the group consisting of naphthenic oils, paraffinic oils, MES oils, TDAE oils, glycerol esters (in particular trioleates), plasticizing hydrocarbon-based resins exhibiting a high Tg preferably of greater than 30° C., and the mixtures of such compounds.

The diene elastomer latex (A) and the aqueous dispersion of filler (B) can also contain coupling agents, coupling activators, agents for covering the reinforcing inorganic filler or more generally processing aids capable, in a known way, by virtue of an improvement in the dispersion of the inorganic or organic filler in the rubber matrix and of a lowering of the viscosity of the compositions, of improving their ease of processing in the crude state, these processing aids being, for example, hydrolysable silanes, such as alkylalkoxysilanes (in particular alkyltriethoxysilanes), polyols, polyethers (for example, polyethylene glycols), primary, secondary or tertiary amines (for example, trialkanolamines), hydroxylated or hydrolysable POSs, for example α,ω-dihydroxypolyorganosiloxanes (in particular α,ω-dihydroxypolydimethylsiloxanes), or fatty acids, such as, for example, stearic acid.

The additives described above could also be incorporated into the masterbatch before the coagulation phase and/or after the formation of the coagulum.

The rubber compositions of the invention are manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at lower temperature, typically below 120° C., for example between 60° C. and 100° C., during which finishing phase the crosslinking or vulcanization system is incorporated.

According to one preferred embodiment of the invention, all the base constituents of the compositions of the invention, with the exception of the vulcanization system, namely the masterbatch, and optional additives of the masterbatch, if appropriate, are intimately incorporated, by kneading, into the diene elastomer during the first “non-productive” phase, that is to say that at least these various base constituents are introduced into the mixer and are thermomechanically kneaded, in one or more steps, until the maximum temperature of between 130° C. and 200° C., preferably of between 145° C. and 185° C., is reached.

By way of example, the first (non-productive) phase is carried out in a single thermomechanical step during which all the necessary constituents, the optional supplementary covering agents or processing aids and various other additives, with the exception of the vulcanization system, are introduced into an appropriate mixer, such as an ordinary internal mixer. The total duration of the kneading, in this non-productive phase, is preferably between 1 and 15 min. After cooling the mixture thus obtained during the first non-productive phase, the vulcanization system is then incorporated at low temperature, generally in an external mixer, such as an open mill; everything is then mixed (productive phase) for a few minutes, for example between 2 and 15 min.

The vulcanization system proper is preferably based on sulphur and on a primary vulcanization accelerator, in particular on an accelerator of the sulphenamide type. Additional to this vulcanization system can be various known secondary vulcanization accelerators or vulcanization activators, with the exception of zinc and any zinc derivative, such as ZnO, or while observing a zinc content of the composition of less than 0.5 phr and preferably of less than 0.3 phr, such as, for example, fatty acids, such as stearic acid, guanidine derivatives (in particular diphenylguanidine), etc., incorporated during the first non-productive phase and/or during the productive phase. The sulphur content is preferably between 0.5 and 3.0 phr, and that of the primary accelerator is preferably between 0.5 and 5.0 phr.

The final composition thus obtained is subsequently calendered, for example in the form of a sheet or plaque, in particular for laboratory characterization, or else extruded in the form of a rubber profiled element which can be used, for example, as a tire tread for a passenger vehicle.

The invention also relates to a masterbatch of diene elastomer and of filler, prepared according to the process described above.

A subject of the invention is also a rubber composition based on at least one masterbatch of diene elastomer and filler, prepared according to the process described above.

The invention also relates to a finished or semi-finished article comprising a composition as defined above.

The invention also relates to a tire tread comprising a composition as defined above.

Finally, a subject of the invention is a tire or semi-finished product comprising at least one rubber composition as defined above.

The following examples serve to illustrate the invention without, however, being limiting in nature.

### EXEMPLARY EMBODIMENTS OF THE INVENTION

### Material Used

Vibracell ultrasound generator, model VCX500 (ref. Fischer W75042), power 500 W, used at 60% of its maximum power;
dialysis tubing (Spectra/Por CE dialysis tubing, 100 kDalton cut-off threshold, 16 mm flat width, 33 foot length). For example, article code 734-0596 in the VWR catalogue;
1 magnetic stirrer+1 magnetic bar;
glassware: beakers of size 15 ml (ref. VWR 15 ml 213-3916); 50 ml (ref. VWR 50 ml 212-9301); 150 ml (ref. VWR 213-3919).

Reagents:

High Ammonia concentrated natural rubber latex at 60% by weight of natural rubber, from Trang Latex CO, LTD, Thailand,

N234 carbon black powder,

Demineralized water,

Sodium dodecyl sulphate (SDS) from Aldrich.

Implementation of the Process According to the Invention by Dialysis

1/Preparation of the Aqueous Dispersion of Carbon Black: Dispersion (B)

The amounts of reagents used are given in the following Table 1. They are expressed in g.

TABLE 1

| | |
|---|---|
| Carbon black | 4.64 |
| SDS | 0.41 (0.35 mol/l) |
| Distilled water | 40 |

After having weighed out the black, the water and the surfactant: sodium dodecyl sulphate denoted SDS, the reagents are brought into contact in a 50 ml glass beaker (low form).

The whole mixture is then homogenized using an ultrasonic probe, twice, for 2 minutes, with a 30 second pause between the two rounds of ultrasound in order to avoid substantial heating of the dispersion.

2/Preparation of the Dialysis Bath: The bath is prepared by adding the desired concentrations of SDS (cf. Table 2) and 41 mmol/1 of dextran to a volume of water of 150 ml. In these experiments, the osmotic pressure of the water is counterbalanced by the addition of dextran to the bath (osmotic counterpressure=0.02 atm, which corresponds to a concentration of 41 mmol/l of dextran).

TABLE 2

| Test | SDS concentration | Chemical potential |
|---|---|---|
| reference | (g/100 ml of water) | of the SDS (J/mol) |
| E1 | 0.4 (0.14 mol/l) | −5.49 × 10² |
| E2 | 0.6 (0.21 mol/l) | 4.48 × 10² |
| E3 | 0.8 (0.28 mol/l) | 1.16 × 10³ |

3/Preparation of the Dispersion (C)

The aqueous dispersion of filler (B) and a solution of natural rubber of identical weight are mixed by gentle stirring with a spatula in order to intimately blend them together.

It is noted that the dispersion obtained is stable.

Next, 2 g of the dispersion (C) are introduced into the previously cut dialysis tubing, and then the sealed tubing is immersed in the bath. The bath is left alone, with stirring by means of a magnetic bar.

After 24 h, the system is at equilibrium. The potential of the surfactant in the bath is equal to the chemical potential of the surfactant in the dispersion (C). Since the volume of the dialysis bath is greater than 50 times the volume of the dispersion (C) in the dialysis bag, the variation in chemical potential in the bath is negligible.

The following table indicates the state of the dispersion (C) after 24 h in the dialysis bath according to the chemical potential of the surfactant in the bath.

TABLE 3

| Test | State of the | Chemical potential |
|---|---|---|
| reference | dispersion C after 24 h | of the SDS (J/mol) |
| E1 | Coagulated | −5.49 × 10² |
| E2 | Uncoagulated | 4.48 × 10² |
| E3 | Uncoagulated | 1.16 × 10³ |

### CONCLUSION

Test E1 corresponds to an experiment carried out according to the invention. Before equilibrium, the aqueous dispersion (C) was stable, i.e. in an uncoagulated state. Consequently, its chemical potential is greater than 0 J/mol. After equilibrium, the chemical potential of the bath is equal to the chemical potential of the aqueous dispersion (C), which is less than 0 J/mol. The reduction in the chemical potential in the dialysis bag allows coagulation of the dispersion (C).

Tests E2 and E3 correspond to experiments which are not carried out according to the invention. After equilibrium, these compositions are still stable and have a chemical potential greater than 0 J/mol.

1. A process for preparing a masterbatch in the liquid phase based on one or more diene elastomer latexes and on one or more fillers which coagulate spontaneously with said latex, comprising the following successive steps:
preparing a stable and homogeneous aqueous dispersion (C) containing one or more surfactants, by mixing
one or more diene elastomer latexes (A) with
one or more aqueous dispersions (B) of one or more fillers which coagulate spontaneously,
homogenizing the aqueous dispersion (C),
reducing the chemical potential of the surfactant in the aqueous dispersion (C) until coagulation of said diene elastomer latex(es) with the filler(s),
recovering the coagulum,
drying the recovered coagulum in order to obtain the masterbatch.

2. The process according to claim 1, wherein the diene elastomer latex is a natural rubber latex.

3. The process according to claim 2, wherein the diene elastomer latex is a concentrated natural rubber latex.

4. The process according to claim 1, wherein the filler is carbon black.

5. The process according to claim 1, wherein the surfactant is an anionic surfactant.

6. The process according to claim 5, wherein the surfactant is sodium dodecyl sulphate.

7. The process according to claim 6, wherein the chemical potential of the surfactant in the aqueous dispersion (C) is strictly greater than 0 J/mol, before coagulation.

8. The process according to claim 1, wherein the reducing of the chemical potential of the surfactant is carried out by dialysis of the aqueous dispersion (C).

9. The process according to any one of claim 1, wherein the reducing of the chemical potential of the surfactant of the aqueous dispersion (C) is carried out by injection of the dispersion (C) into a volume of aqueous solution, with a precoagulation step beforehand.

10. The process according to claim 1, wherein the recovering the coagulum is carried out by means of a filtering operation.

11. The process according to claim 1, wherein the recovering the coagulum is carried out by means of a centrifugation operation.

12. A masterbatch of diene elastomer and of filler, prepared according to the process of claim 1.

13. A rubber composition based on at least one masterbatch of diene elastomer and of filler, prepared according the process of claim 1.

14. A finished or semi-finished article comprising a rubber composition according to claim 13.

15. A tire tread comprising a rubber composition according to claim 13.

16. A tire or semi-finished product comprising at least one rubber composition according to claim 13.
